(19) United States
(12) Patent Application Publication
(10) Pub. No.: US 2018/0165627 A1
(43) Pub. Date: Jun. 14, 2018

(54) Systems and Methods for Estimating Product Inventory

(71) Applicant: Wal-Mart Stores, Inc., Bentonville, AR (US)

(72) Inventors: Matthew A. Jones, Bentonville, AR (US); Nicholaus A. Jones, Fayetteville, AR (US)

(21) Appl. No.: 15/833,215

(22) Filed: Dec. 6, 2017

Related U.S. Application Data
(60) Provisional application No. 62/432,826, filed on Dec. 12, 2016.

(51) Int. Cl. G06Q 10/08; G06K 7/14; G06K 7/10

(52) U.S. Cl. CPC G06Q 10/087; G06K 2007/10524; G06K 7/10881; G06K 7/1413

(57) ABSTRACT

Systems, apparatuses and methods are provided herein for estimating product inventory in a retail facility. A system for inventory management comprises: a reusable container comprising a series of computer readable markings stacked vertically along a sidewall of the container such that each computer readable marking corresponds to a possible fill line level of a product in the container, a handheld device, and a control circuit configured to obtain scan data from a computer readable marking that corresponds to a fill line level of the product in the container, and estimate a weight of the product in the container at the particular fill line level by comparing the particular fill line level to a known weight of the product in the container.

### RELATED APPLICATION

This application claims the benefit of U.S. Provisional Application No. 62/423,826 filed on Dec. 12, 2016, which is incorporated herein by reference in its entirety.

### TECHNICAL FIELD

The field of this invention relates generally to inventory management of products in a retail facility, and more particularly, relates to systems and methods for managing product inventory with reusable product containers in a retail facility.

### BACKGROUND

In modern retail environments, there is a need to consistently maintain an adequate inventory of products. Certain products, such as, for example, fruits, vegetables, and other produce, are often delivered from the supplier to the retail facility in a reusable container. In some cases, the product may be displayed to the consumer directly in the reusable container. For example, the reusable container containing the product may be incorporated into a display in the produce section of the retail facility. In other cases, an amount of the product may be removed from the reusable container and displayed in a secondary container in the produce section of the retail facility, while the remainder of the product is stored in the reusable container. In either case, it is important for the store workers to quickly and efficiency monitor the inventory of the product in the reusable container.

### BRIEF DESCRIPTION OF THE DRAWINGS

Disclosed herein are embodiments of systems, apparatuses and methods pertaining to estimating product inventory in a retail facility. This description includes drawings, wherein:

FIG. 1 illustrates a block diagram of a system in accordance with some embodiments.

FIG. 2 illustrates a perspective view of a reusable container in accordance with some embodiments.

FIG. 3 illustrates a perspective view of a reusable container in accordance with some embodiments.

FIG. 4 illustrates a perspective view of a reusable container in accordance with some embodiments.

FIGS. 5A-5C illustrates front views of the reusable container illustrated in FIG. 4.

FIG. 6 illustrates a simplified flow diagram of a method for estimating product container inventory in a retail facility, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful for estimating product inventory in a retail facility. Embodiments may include a reusable container comprising a series of computer readable markings stacked vertically along a sidewall of the container such that each computer readable marking corresponds to a possible fill line level of a product in the container. The computer readable markings may contain data corresponding to a weight of one or more products at each of the markings respective fill line levels, with each computer readable marking being capable of conveying said data when scanned or otherwise detected. Some embodiments include a handheld device configured to scan the computer readable markings.

Embodiments may also include a product database containing product information, and a control circuit communicatively coupled to the product database and the handheld device, the control circuit being configured to obtain scan data, via the handheld device, from a computer readable marking that corresponds to a fill line level of the product in the container, and estimate a weight of the product in the container at the particular fill line level by comparing the fill line level associated with the scanned computer readable marking to a fill line level associated with a known weight of the product in the container. In some embodiments, the fill line level associated with a known weight of the product may be a baseline fill line level. In some embodiments, the fill line level associated with a known weight of the product may be a fill line level in which the weight of product was previously estimated.

In some embodiments, the system may further include an inventory database, and the control circuit may be configured to detect a change in an inventory level of the product by comparing successive scans of computer readable markings corresponding to different fill line levels of the product in the container at different times. In such a case, the system may update the inventory database with a new inventory level when a change in the inventory level is detected. In some embodiments the system may automatically provide an alert when the estimated weight of the product in the container falls below a predetermined value.

Typically, products such as fruits, vegetables, and other produce are often transported from the supplier, distributor, grower, or the like in a reusable container. Typical reusable container include reusable plastic containers having the shape of a rectangular box or crate. Generally, when products such as fruits, vegetables, and other produce are transported to the retail facility in reusable containers, each reusable container contains a known weight of product. Products stored in the reusable container generally have a characteristic height associated with the weight, shape, and density of the product and the dimensions of the container. The product height in the container is commonly referred to as the “fill line.” For example, a container having specific dimensions and containing a known weight of a specific product may have a lower fill line level than a wider container containing the same weight of the same product. Similarly, a container having specific dimensions and containing a known weight of a specific product may have a lower fill line level than the same container containing the same weight of a larger-sized, less dense product. The systems, apparatuses and methods provided herein employ a reusable container comprising a series of computer readable markings stacked vertically along a sidewall of the container. Each computer readable marking corresponds to a possible fill line level of a specific product in the container, which correspond to weights of the specific product in the specific container, allowing an automatic estimation of a weight of the product based on the fill line level of the product in the container. Such an estimation is especially useful in monitoring inventory levels. For example, changes in inventory level of a product can be detected and analyzed by weight based on successive scans of computer readable markings corresponding to different fill line levels of the product in the container.

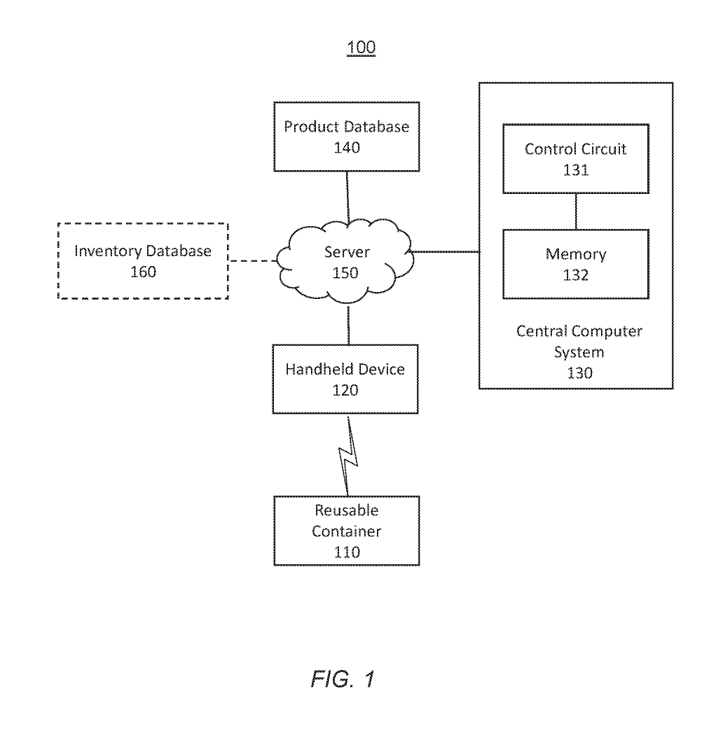

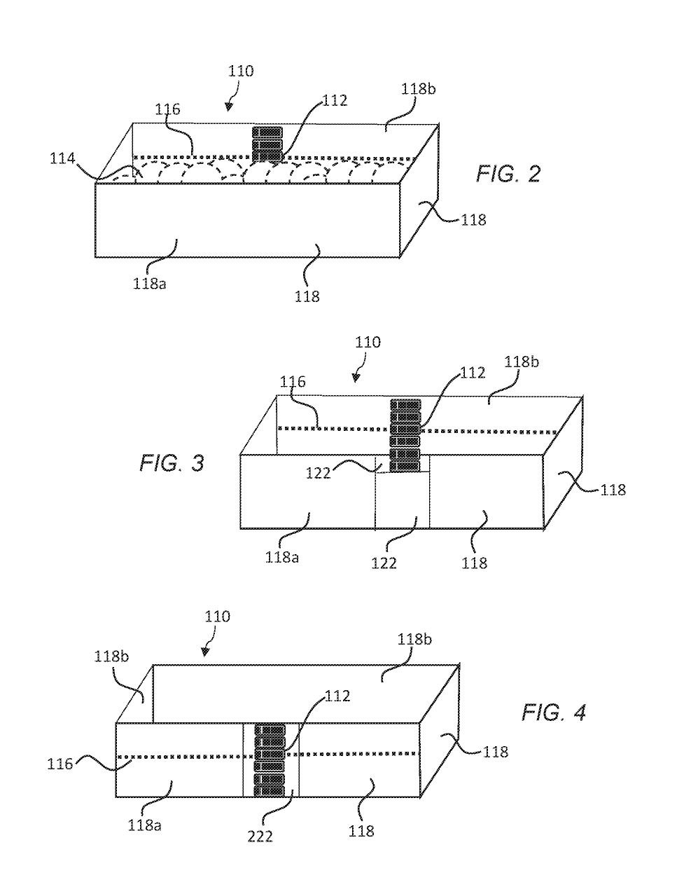

FIG. 1 illustrates an embodiment of a system for estimating product inventory in a retail facility. The system 100 includes a reusable container 110. Non-limiting embodiments of exemplary reusable containers are illustrated in FIGS. 2-4. Reusable container 110 may comprise a series of computer readable markings 112 stacked vertically along a sidewall 118 of the container 110 such that each computer readable marking 112 corresponds to a possible fill line level 116 of a product in the container 110. The computer readable markings may contain data corresponding to a weight of a product at each of the markings' respective fill line levels and may be capable of conveying said data when scanned or otherwise detected.

The system also includes a handheld device 120 configured to scan the computer readable markings, central computer system 130, and a product database 140 containing product information. In some embodiments, the system may also include an inventory database 160 comprising inventory levels of the one or more of the products in the product database 140. The central computer system 130 may be directly or indirectly communicatively coupled with the handheld device 120, product database 140, and inventory database 160 through one or more wired and/or wireless distributed communication networks 150 (e.g., LAN, WAN, Internet, etc.).

The central computer system 130 includes a control circuit 131 and a memory 132 and may generally be any processor-based device such as one or more of a computer system, a server, a networked computer, a cloud-based server, etc. The control circuit 131 may comprise a central processing unit, a processor, a microprocessor, and the like. The control circuit 131 may be configured to execute computer readable instructions stored on the memory 132. The memory 132 may comprise volatile and/or non-volatile computer readable storage memory and have stored upon it a set of computer readable instructions which, when executed by the control circuit 131, causes the system to estimate a weight of a product in the container 110 at a particular fill line level 116. The central computer system 130 may be coupled to the handheld device 120 via a wireless signal connections.

In some embodiments, the central computer system 130 may be configured to obtain an identification of the product in the container 110. In some embodiments, the central computer system 130 may obtain a product identification via a user interface, wherein a user, such as, for example, a store worker, inputs an identifier, such as a product number, associated with the specific product. For example, a store worker may utilize a user interface on the handheld device 120 to input a product code related to the product or other product identifier. In some embodiments, the central computer system 130 may obtain a product identification when a computer readable marking, such as a bar code, on the product itself is scanned by handheld device 120, or by a separate handheld device.

The central computer system 130 is generally configured to obtain scan data, via the handheld device 120, from a computer readable marking 112 that corresponds to a fill line level 116 of the product in the container 110. In some embodiments, the central computer system 130 may be configured to update the inventory database 160 with the scan data obtained from the handheld device 120 and/or with estimated inventory levels. In some embodiments, one or more product identifiers may be included in the scan data obtained by the handheld device 120 when scanning the computer readable marking 116. The central computer system 130 may then be configured to estimate a weight of the product in the container 110 at the particular fill line level 116 by comparing the fill line level 116 associated with the scanned computer readable marking 112 to a fill line level 116 associated with a known weight of the product in the container 100. In some embodiments, the fill line level 116 associated with a known weight of the product may be a baseline fill line level. For example, when a reusable container 110 containing a known weight of a product arrives at a retail facility, a computer readable marking 112 on the reusable container 110 that corresponds to the fill line level 116 of the product in the container 110 may be scanned by the handheld device 120. The central computer system 130 may then associate the known weight of the product in the container with the particular fill line level 116 at the scanned computer readable marking 112 to determine a baseline fill line level. The central computer system 130 may use the baseline fill line level to calculate weights of the product associated with subsequently scanned computer readable markings as the fill line level/weight of the product decreases over time. In some embodiments, the fill line level associated with a known weight of the product may be a fill line level in which the weight of product was previously estimated.

For each product that may be transported or displayed in a reusable container 110, the product database 140 may store data associating various fill line levels 116 of each product with weights of each product in various reusable containers 110. For example, apples arriving at a retail facility may be transported in reusable containers containing 40 pounds of apples in each container. The 40 pounds of apples in each container will generally have a similar fill line level for each similarly sized and shaped reusable container 110. In some embodiment, the central computer system 130 may associate the 40 pounds of apples in the reusable container 110 with the fill line level 116 of the apples in the container 110 to determine the baseline fill line level of the apples in the reusable container 110. As apples are removed from the reusable container 110 (i.e., as the weight of the apples in the reusable container decreases), the fill line level 116 generally decreases in height. The product database 140 may store data associating various fill line levels with various weights for each product and for each size/shape of reusable container, which the central computer system 130 may access to estimate a weight of a product at a particular fill line level.

The product database 140 and the optional inventory database 160 generally comprise volatile and/or non-volatile computer readable storage memory device(s). While the product database 140 and the optional inventory database 160 are shown as separate components from the memory 132 of the central computer system 130 in FIG. 1, in some embodiments, the product database 140 and the memory 132 may be implemented with the same one or more memory devices. In some embodiments, the inventory database 160 and the memory 132 may be implemented with the same one or more memory devices. In some embodiments, the product database 140, the inventory database 160, and the memory 132 may be implemented with the same one or more memory devices.

In some embodiments, central computer system 130 may be configured to detect a change in an inventory level of the product by comparing successive scans of computer readable markings corresponding to different fill line levels 116 of the product in the container 110 at different times. For example, as the inventory of the product in the reusable container decreases, the fill line level of the product in the container 110 may also decrease. The central computer system 130 may estimate a change in weight of the product in a reusable container 110 based on the scan data obtained from successive scans of computer readable markings 112 associated with decreasing fill line levels 116. In some embodiments, the central computer system 130 may be further configured to update the inventory database 160 with a new inventory level when a change in the inventory level is detected. In some embodiments, the central computer system 130 may be further conjured to automatically provide an alert when the estimated weight of the product in the container falls below a predetermined value.

Some embodiments may include a plurality of reusable containers 110, with each container 110 comprising a series of computer readable markings 112 stacked vertically along a sidewall of the container 110 such that each computer readable marking 112 corresponds to a possible fill line level 116 of a product in the container 110, and each computer readable marking 112 is associated with a weight of the product at the corresponding fill line level 116 in the container 110. In some embodiments, each reusable container 110 may contain the same product. In other embodiments, each reusable container 110 may contain a different product. The central computer system 130 may be configured to update the inventory database 160 with a new inventory level when a change in the inventory level of each product and/or in each reusable container 110 is detected. In this way, the central computer system 130 may be configured to track the product inventory of each reusable container 110, which may contain the same or different products, and/or the central computer system 130 may be configured to track a total product inventory for each product by aggregating product inventories for each reusable container 110.

The handheld device 120 may comprise any suitable portable device that is capable of obtaining data from computer readable markings 112 on the reusable container 110. The handheld device 120, having obtained scan data from a computer readable marking 112 on a reusable container 110, transmits the data to the central computer system 130, which is directly or indirectly communicatively coupled with the handheld device 120 through one or more wired and/or wireless distributed communication networks 150 (e.g., LAN, WAN, Internet, etc.). The handheld device 120 may comprise, for example, a personal computer, a laptop computer, or a handheld communication device such as a mobile phone or tablet or the like. In some embodiments, the handheld device may include a barcode reader/scanner.

The reusable container 110 may comprise any conventional reusable container that is suitable for transporting, storing, and or displaying products, such as, for example, fruits, vegetables, and other produce, in a retail facility. The reusable container 110 may formed of any suitable material and may be any suitable size and/or shape. Generally, the reusable container 110 may include a plurality of rigid sidewalls 118 that contact a rigid base surface. Each sidewall 118 may have an outer surface 118a and an inner surface 118b, the inner surface 118b facing the interior of the container 110. In some embodiments, the reusable container 110 may comprise a rigid, 5-sided container. The container 110 may be an open-top container, or the container may include a lid. In some embodiments, the reusable container 110 is a reusable plastic container, which is commonly known as an “RPC.”

In some embodiments, the reusable container 110 may be formed from at least one material selected from the group consisting of polyethylene, polypropylene, polyvinyl chloride, polyurethane, polyester, epoxy resin, phenolic resin, polystyrene, polycarbonate, and combinations thereof. The reusable container 110 may or may not include a lid, depending on the intended use of the container. When the container does include a lid, the lid may comprise the same or different materials as the body of the container 110.

FIGS. 2-5 illustrate in more detail various exemplary reusable containers that may be used in the systems and methods described herein. As illustrated in FIGS. 2-4, the reusable container 110 may comprise a series of computer readable markings 112 stacked vertically along a sidewall 118 of the container 110. As explained above, each computer readable marking 112 corresponds to a possible fill line level 116 of a specific product in the specific container 110 and contains data corresponding to a weight of one or more products at the marking's respective fill line level. The computer readable markings 112 may comprise any computer readable markings that are capable of conveying data when scanned or otherwise detected. The computer readable markings 112 may be printed or otherwise displayed on a material that is affixed to an interior or exterior surface of a sidewall 118 of the container 110. For example, in some embodiments, the computer readable markings 112 may comprise a series of barcodes printed on stickers or labels having an adhesive surface, which are stacked vertically along a sidewall 118 of the container 110.

A non-limiting, exemplary embodiment of reusable container 110 is illustrated in FIG. 2, wherein a series of computer readable markings 112 is affixed to an internal surface 118b of a sidewall 118 of the reusable container 110. In FIG. 2, each computer readable marking 112 corresponds to a possible fill line level 116 of a product 114 in the container 110. In this embodiment, when the reusable container 110 contains an amount of product 114, the product 114 will obscure a lower portion of the series of computer readable markings 112 from view, with the height of the product 114 in the container 110 representing the fill line level 116 of the product 114. To estimate a weight of a product 114 in the container 110, a store worker may scan the computer readable marking 112 corresponding to the fill line level 116 from above the product 114 using a handheld device. The handheld device may comprise handheld device 120 described with reference to FIG. 1

In some exemplary, non-limiting embodiments, as illustrated in FIGS. 3 and 4, a portion of the container 110 may comprise a transparent section 122 disposed vertically along the sidewall 118 of the container 110. As illustrated in FIG. 3, the series of computer readable markings 112 may be arranged vertically on an internal surface 118b of the container 110 opposite the transparent section 122, such that the series of computer readable markings 112 is visible through the transparent section 122 of the container from outside the container 110. When the container 110 contains an amount of product (not pictured in FIG. 3), the product will obscure a lower portion of the series of computer readable markings 112 from view through the transparent section 122 of the container 110. As in FIG. 2, the height of the product in the container 110 would represent a fill line level 116 of the product. To estimate a weight of a product in the container 110, a store worker may scan a computer readable marking 112 corresponding to the fill line level 116 from above the product or through the transparent section 122 using a handheld device. The handheld device may comprise handheld device 120 described with reference to FIG. 1

As illustrated in FIG. 4, the series of computer readable markings 112 may be arranged vertically on an internal surface 118b or external surface 118a of the transparent section 122 of the container 110. For example, in embodiments where the computer readable markings comprise a barcode label, the label may comprise an adhesive on the front side of the label (i.e., the side of the label displaying the barcode) and the label may be affixed to an internal surface 118b of the transparent section 122 such that the barcode is visible through the transparent section 122. Conversely, the label may comprise an adhesive on the back side of the label and the label may be affixed to an external surface 118a of the transparent section 122 such that the barcode is visible on the exterior surface of the transparent section 122. In either case, when the container 110 contains an amount of product (not pictured in FIG. 4), the product in the reusable container 110 will generally not obscure a portion of the computer readable markings 112 when viewed from the exterior of the container 110. As in FIGS. 2 and 3, the height of the product in the container 110 would represent a fill line level 116 of the product. To estimate a weight of a product in the container 110, a store worker may scan from the exterior of the container a computer readable marking 112 affixed to the transparent section 122 of the container, the scanned computer readable marking 112 corresponding to the fill line level 116, using a handheld device. The handheld device may comprise handheld device 120 described with reference to FIG. 1. The system may estimate a weight of the product in the container 110 at the particular fill line level 116 by comparing the fill line level 116 associated with the scanned computer readable marking 112 to a fill line level 116 associated with a known weight of the product in the container 100. In some embodiments, the fill line level 116 associated with a known weight of the product may be a fill line level 116 in which the weight of product was previously estimated. In some embodiments, the fill line level 116 associated with a known weight of the product may be a baseline fill line level. For example, when a reusable container 110 containing a known weight of a product 114 arrives at a retail facility, a computer readable marking 112 on the reusable container 110 that corresponds to the fill line level 116 of the product 114 in the container 110 may be scanned by the store worker using handheld device 120. The central computer system 130 may then associate the known weight of the product 114 in the container 110 with the particular fill line level 116 to determine a baseline fill line level. The central computer system 130 may use the baseline fill line level to calculate weights of the product 114 associated with subsequently scanned computer readable markings 112 as the fill line level/weight of the product 114 decreases over time.

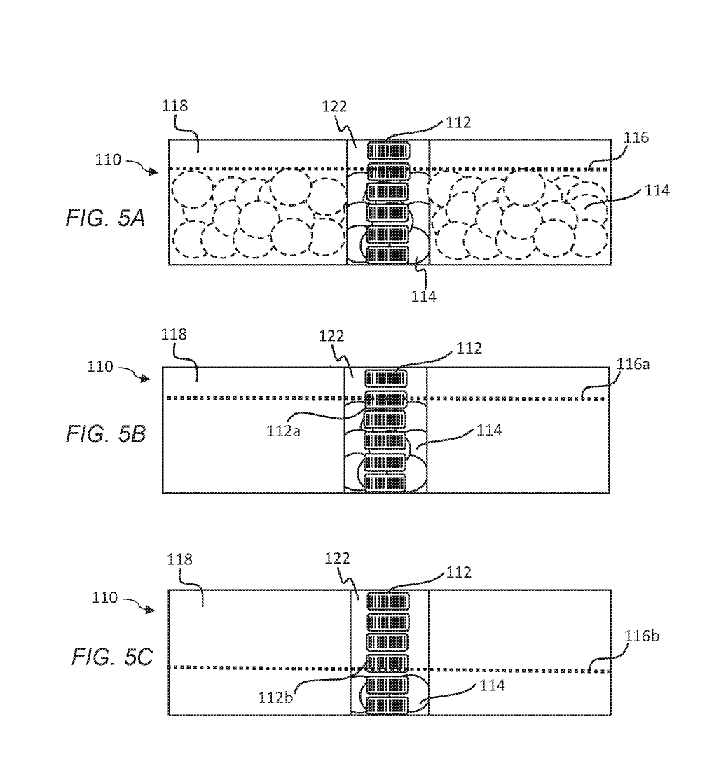

FIGS. 5A-5C further illustrate a front view of the reusable container 110 depicted in FIG. 4. As illustrated in FIG. 5A, reusable container 110 comprises a transparent section 122 disposed vertically along the sidewall 118 of the container 110, and the series of computer readable markings 112 is arranged vertically on an internal or external surface of the transparent section 112 of the container 110. An amount of product 114 is visible through the transparent section 122, with the height of the product denoting a fill line 116.

In FIG. 5B, fill line 116a corresponds to the placement of computer readable marking 112a. Computer readable marking 112a is associated with a first weight of the product 114 at the fill line level 116a. FIG. 5C illustrates a second fill line level 116b, which corresponds to the placement of second computer readable marking 112b. Computer readable marking 112b is associated with a second weight of the product 114 at the fill line level 116b. The second fill line level 116b is lower in height than the first fill line level 116a, denoting a likely decrease in the weight of the product 114 over a period of time. To estimate a first weight of a product in the container 110, a store worker may scan from the exterior of the container first computer readable marking 112a affixed to the transparent section 122 of the container, the scanned computer readable marking 112a corresponding to the fill line level 116a, using a handheld device. The scanned computer readable marking 112a may be associated with a weight of the product 114 in the container 110 at fill line level 116a by comparing the fill line level 116a to a fill line level associated with a known weight of the product 114. In some embodiments, the fill line level associated with a known weight of the product 114 may be a fill line level in which the weight of product was previously estimated. In some embodiments, the fill line level associated with a known weight of the product 114 may be a baseline fill line level.

To estimate a second weight of a product in the container 110 at the second fill line level 116b, and to detect a change in inventory levels of the product in the container 110, a store worker may scan the second computer readable marking 112b, which is associated with a second weight of the product 114 in the container 110 at fill line level 116b by comparing the fill line level 116b to the previously estimated weight associated with fill line level 116a. In some embodiments, the system may also utilize data associated with the baseline fill level to estimate a second weight of a product in the container 110 at the second fill line level 116b. As discussed above, data associating various fill line levels with various weights for each product and for each size/shape of reusable container may be stored in a database, such as, for example product database 140 discussed above with reference to FIG. 1. The system may access the stored data to estimate a weight of a product 114 at a particular fill line level 116.

In some embodiments, the system may update the inventory database with a new inventory level when a new inventory level and/or a change in the inventory level of the product 114 is detected. In some embodiments, the system may automatically provide an alert when the estimated weight of the product 114 in the container 110 falls below a predetermined value. For example, in some embodiments, the system may alert a store worker by causing the store worker's handheld device to emit an audio or vibrating alert. For example, the handheld device may be configured to emit a specific pattern of vibration or sound, or a specific audio tone and/or frequency to alert the store worker when the weight of the product 114 in the container 110 falls below a predetermined value. In some embodiments, the handheld device may be configured to display a text message alerting the store worker to low product inventory levels. In some embodiments, the handheld device may be configured to display the estimated inventory levels of one or more products having a weight below the predetermined threshold and/or may be configured to display instructions for the store worker regarding how to respond.

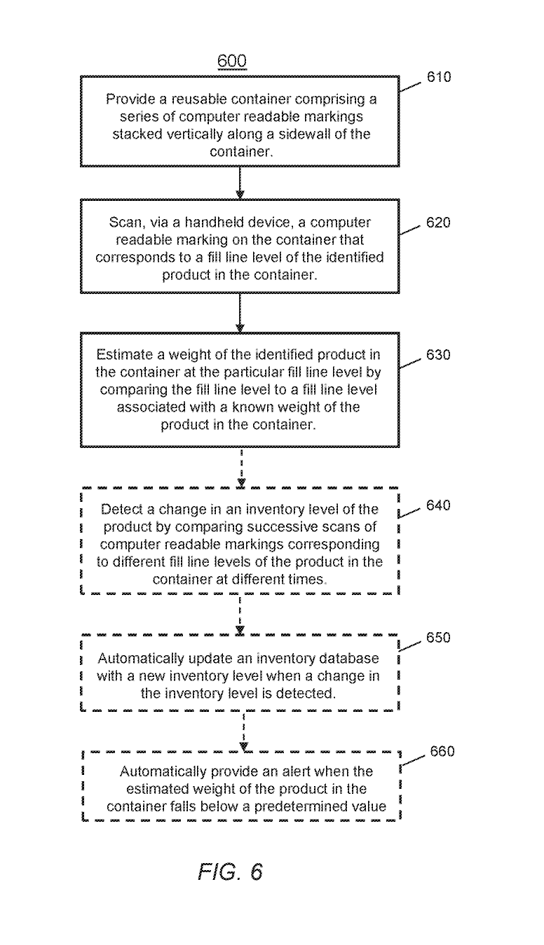

Referring now to FIG. 6, a method for estimating product container inventory in a retail facility is shown. Generally, the method shown in FIG. 6 may be implemented with a processor based device such as a control circuit, a central processor, and the like. In some embodiments, the method shown in FIG. 6 may be implemented with the central computer system 130 in FIG. 1.

In step 610, a reusable container is provided, which comprises a series of computer readable markings stacked vertically along a sidewall of the container such that each computer readable marking corresponds to a possible fill line level of a product in the container. In some embodiments, the reusable container may comprise reusable container 110 described with reference to FIGS. 1-5. The reusable container may comprise any conventional reusable container that is suitable for transporting, storing, and or displaying products, such as, for example, fruits, vegetables, and other produce, in a retail facility. The reusable container may formed of any suitable material and may be any suitable size and/or shape. Generally, the reusable container may include a plurality of rigid sidewalls that contact a rigid base surface. Each sidewall may have an outer surface and an inner surface, the inner surface facing the interior of the container. The container 110 may be an open-top container, or the container may include a lid. In some embodiments, the reusable container 110 is a reusable plastic container, which is commonly known as an “RPC.”

In some embodiments, the reusable container 110 may be formed from at least one material selected from the group consisting of polyethylene, polypropylene, polyvinyl chloride, polyurethane, polyester, epoxy resin, phenolic resin, polystyrene, polycarbonate, and combinations thereof. In some embodiments, the reusable container may comprise a rigid, 5-sided container. The reusable container may or may not include a lid, depending on the intended use of the container. When the container does include a lid, the lid may comprise the same or different materials as the body of the container.

As illustrated in FIGS. 2-4, the reusable container may comprise a series of computer readable markings stacked vertically along a sidewall of the container. Each computer readable marking corresponds to a possible fill line level of a specific product in the specific container. The computer readable markings may comprise any computer readable markings that are capable of conveying data when scanned or otherwise detected. The computer readable markings may be printed or otherwise displayed on a material that is affixed to an interior or exterior surface of a sidewall of the container. For example, in some embodiments, the computer readable markings may comprise a series of barcodes printed on stickers or labels comprising an adhesive surface that are stacked vertically along a sidewall of the container.

In some embodiments, as illustrated in FIG. 2, the series of computer readable markings may be arranged vertically on an internal surface of the sidewall of the container. In some embodiments, as illustrated in FIG. 3, a portion of the container comprises a transparent section disposed vertically along the sidewall of the container, and the series of computer readable markings is arranged vertically on an internal surface of the container opposite the transparent section such that the series of computer readable markings is visible through the transparent section of the container from outside the container. In some embodiments, as illustrated in FIGS. 4 and 5, a portion of the container comprises a transparent section disposed vertically along the sidewall of the container, and the series of computer readable markings is arranged vertically on an internal or external surface of the transparent section of the container.

In step 620, a computer readable marking on the container that corresponds to a fill line level of the product in the container is scanned via a handheld device. In some embodiments, the handheld device may comprise handheld device 120 described with reference to FIG. 1. The handheld device may comprise any suitable portable device that is capable of obtaining data from computer readable markings on the reusable container. The handheld device may comprise, for example, a personal computer, a laptop computer, or a handheld communication device such as a mobile phone or tablet or the like. In some embodiments, the handheld device may include a barcode reader/scanner. The handheld device, having obtained scan data from a computer readable marking on a reusable container, may transmit the data to the system.

In step 630, the system may automatically estimate a weight of the product in the container at the particular fill line level. The weight of the product in the container may be estimated by comparing the fill line level associated with the scanned computer readable marking with a fill line level associated with a known weight of the product in the container. In some embodiments, the fill line level associated with a known weight of the product may be a fill line level in which the weight of product was previously estimated. In some embodiments, the fill line level associated with a known weight of the product may be a baseline fill line level. For example, when a reusable container containing a known weight of a product arrives at a retail facility, a computer readable marking on the reusable container that corresponds to the fill line level of the product in the container may be scanned by the store worker using a handheld device. The system may then associate the known weight of the product in the container with the particular fill line level to determine a baseline fill line level. The system may then use the baseline fill line level to calculate weights of the product associated with subsequently scanned computer readable markings as the fill line level/weight of the product decreases over time.

For each product that may be transported or displayed in a reusable container, a product database may store data associating various fill line levels of each product with weights of each product in various reusable containers. For example, apples arriving at a retail facility may be transported in reusable containers containing 40 pounds of apples in each container. The 40 pounds of apples in each container will generally have a similar fill line level for each similarly sized and shaped reusable container. As apples are removed from the reusable container (i.e., as the weight of the apples in the reusable container decreases), the fill line level generally decreases in height. The product database may store data associating various fill line levels with various weights for each product and for each size/shape of reusable container, which the system may access to estimate a weight of a product at a particular fill line level. In some embodiments, the product database may comprise product database 140 described with reference to FIG. 1. The method described herein allows the store worker to quickly and efficiently estimate the weight of the product in the container at any given time simply by scanning the computer readable marker that corresponds to the fill line level of the product in the container.

In optional step 640, the system may automatically detect a change in an inventory level of the product by comparing successive scans of computer readable markings corresponding to different fill line levels of the product in the container at different times, as discussed with reference to FIGS. 5A-5C. For example, as the inventory of the product in the reusable container decreases, the fill line level/weight of the product in the container also decreases. The system may estimate a change in weight of the product in a reusable container based on the scan data obtained from successive scans of computer readable markings associated with decreasing fill line levels in the container, which may, in some embodiments, also be compared to the baseline fill line level.

In optional step 650, the system may be further configured to update an inventory database with a new inventory level when a new inventory level and/or a change in the inventory level of one or more products is detected. In some embodiments, the inventory database may comprise inventory database 160 described with reference to FIG. 1.

In embodiments where a plurality of reusable containers are employed, each container may comprise a series of computer readable markings stacked vertically along a sidewall of the container such that each computer readable marking corresponds to a possible fill line level of a product in the container, and each computer readable marking is associated with a weight of the product at the corresponding fill line level in the container. In some embodiments, each reusable container may contain the same product. In other embodiments, each reusable container may contain a different product. The system may be configured to update the inventory database with a new inventory level when a new inventory level and/or a change in the inventory level of each product and/or in each reusable container is detected. In this way, system may be configured to track the product inventory of each reusable container, which may contain the same or different products, and/or the system may be configured to track a total product inventory for each product by aggregating product inventories for each reusable container.

In optional step 650, the system may be further conjured to automatically provide an alert when the estimated weight of the product in the container falls below a predetermined value. For example, in some embodiments, the system may alert a store worker by causing the store worker's the handheld device to emit an audio or vibrating alert. For example, the handheld device may be configured to emit a specific pattern of vibration or sound, or a specific audio tone and/or frequency to alert the store worker when the weight of the product in the container falls below a predetermined value. In some embodiments, the handheld device may be configured to display a text message alerting the store worker to low product inventory levels. In some embodiments, the handheld device may be configured to display the estimated inventory levels of one or more products having a weight below the predetermined threshold and/or may be configured to display instructions for the store worker regarding how to respond.

In one embodiment, a system for estimating product inventory in a retail facility comprises: a reusable container; a series of computer readable markings stacked vertically along a sidewall of the container such that each computer readable marking corresponds to a possible fill line level of a product in the container; a handheld device configured to scan the computer readable markings; a product database containing product information; and a control circuit coupled to the handheld device and the product database, the control circuit configured to: obtain scan data, via the handheld device, from a computer readable marking that corresponds to a fill line level of the product in the container; and estimate a weight of the product in the container at the particular fill line level by comparing the particular fill line level to a known weight of the product in the container.

In one embodiment, an apparatus for estimating product inventory comprises: a reusable container configured to store a plurality of products, the reusable container comprising a plurality of sidewalls and a base, each of the plurality of sidewalls being connected to the base; and a series of computer readable markings stacked vertically along one of the plurality of sidewalls such that each of the computer readable markings corresponds to a possible fill line level of the plurality of products in the container, wherein each of the computer readable markings contains data corresponding to a weight of the plurality of products at its respective fill line level and each of computer readable markings is capable of conveying said data when scanned or otherwise detected.

In one embodiment, a method of estimating product inventory in a retail facility comprises: providing a reusable container comprising a series of computer readable markings stacked vertically along a sidewall of the container such that each computer readable marking corresponds to a possible fill line level of a product in the container; scanning, via a handheld device, a computer readable marking on the container that corresponds to a fill line level of the product in the container; and estimating a weight of the product in the container at the particular fill line level by comparing the particular fill line level to a known weight of the product in the container.

It should be understood that each of the components of the system described herein may be in communication with one another using any conventional communications protocol, including wireless communication protocols. Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for estimating product inventory, the system comprising:
a reusable container;
a series of computer readable markings stacked vertically along a sidewall of the container such that each computer readable marking corresponds to a possible fill line level of a product in the container;
a handheld device configured to scan the computer readable markings;
a product database containing product information; and
a control circuit coupled to the handheld device and the product database, the control circuit configured to:
obtain scan data, via the handheld device, from a computer readable marking that corresponds to a fill line level of the product in the container; and
estimate a weight of the product in the container at the particular fill line level by comparing the particular fill line level to a known weight of the product in the container.

2. The system of claim 1, wherein the known weight of the product in the container corresponds to a baseline fill line level.

3. The system of claim 1, wherein the system further comprises an inventory database, and the control circuit is further configured to:
detect a change in an inventory level of the product by comparing successive scans of computer readable markings corresponding to different fill line levels of the product in the container at different times; and
update the inventory database with a new inventory level when a change in the inventory level is detected.

4. The system of claim 1, wherein the control circuit is further conjured to automatically provide an alert when the estimated weight of the product in the container falls below a predetermined value.

5. The system of claim 1, wherein the container is formed from at least one material selected from the group consisting of polyethylene, polypropylene, polyvinyl chloride, polyurethane, polyester, epoxy resin, phenolic resin, polystyrene, polycarbonate, and combinations thereof.

6. The system of claim 1, wherein the series of computer readable markings comprises a series of barcodes stacked vertically along the sidewall of the container.

7. The system of claim 1, wherein the series of computer readable markings is arranged vertically on an internal surface of the sidewall of the container.

8. The system of claim 1, wherein a portion of the container comprises a transparent section disposed vertically along the sidewall of the container, and the series of computer readable markings is arranged vertically on an internal or external surface of the transparent section of the container.

9. The system of claim 1, wherein a portion of the container comprises a transparent section disposed vertically along the sidewall of the container, and the series of computer readable markings is arranged vertically on an internal surface of the container opposite the transparent section such that the series of computer readable markings is visible through the transparent section of the container from outside the container.

10. The system of claim 1, further comprising a plurality of reusable containers, each container comprising a series of computer readable markings stacked vertically along sidewall of the container such that each computer readable marking corresponds to a possible fill line level of a product in the container, and each computer readable marking is associated with a weight of the product at the corresponding fill line level in the container.

11. The system of claim 10, wherein each container contains a same product.

12. The system of claim 10, wherein each container contains a different product.

13. An apparatus for estimating product inventory comprising:
a reusable container configured to store a plurality of products, the reusable container comprising a plurality of sidewalls and a base, each of the plurality of sidewalls being connected to the base; and
a series of computer readable markings stacked vertically along one of the plurality of sidewalls such that each of the computer readable markings corresponds to a possible fill line level of the plurality of products in the container,
wherein each of the computer readable markings contains data corresponding to a weight of the plurality of products at its respective fill line level and each of computer readable markings is capable of conveying said data when scanned or otherwise detected.

14. The apparatus of claim 13, wherein the series of computer readable markings is arranged vertically on an internal surface of the one of the plurality of sidewalls.

15. The apparatus of claim 13, wherein the one of the plurality of sidewalls includes a transparent section disposed vertically along the one of the plurality of sidewalls, and the series of computer readable markings is arranged vertically on an internal or external surface of the transparent section of the one of the plurality of sidewalls.

16. The apparatus of claim 13, wherein the container comprises a first sidewall and a second sidewall, the second sidewall being disposed opposite the first sidewall,
the first sidewall includes a transparent section that is disposed vertically along the first sidewall, and
the series of computer readable markings is arranged vertically on a portion of an internal surface of the second side wall that is opposite the transparent section of the first sidewall, such that the series of computer readable markings on the internal surface of the second sidewall is visible through the transparent section of the first sidewall from outside the container.

17. The apparatus of claim 16, wherein the transparent section of the first sidewall is configured to allow the series of computer readable markings on the internal surface of second sidewall to be scanned or otherwise detected through the transparent section of the first sidewall.

18. The apparatus of claim 13, wherein the container is formed from at least one material selected from the group consisting of polyethylene, polypropylene, polyvinyl chloride, polyurethane, polyester, epoxy resin, phenolic resin, polystyrene, polycarbonate, and combinations thereof.

19. The apparatus of claim 13, wherein the series of computer readable markings comprises a series of barcodes stacked vertically along the one of the plurality of sidewalls of the container.

20. A method for estimating product inventory, the method comprising:
providing a reusable container comprising a series of computer readable markings stacked vertically along a sidewall of the container such that each computer readable marking corresponds to a possible fill line level of a product in the container;
scanning, via a handheld device, a computer readable marking on the container that corresponds to a fill line level of the product in the container; and
estimating a weight of the product in the container at the particular fill line level by comparing the particular fill line level to a known weight of the product in the container.
